(19) United States
(12) Patent Application Publication
(10) Pub. No.: US 2026/0249404 A1
(43) Pub. Date: Aug. 27, 2026

(54) GATE VALVE SEAT PULLER

(71) Applicant: Supreme Production Services, Inc., Corpus Christi, TX (US)

(72) Inventors: Lauren Gayle Tipps, Corpus Christi, TX (US); George Dewey Clark, IV, Orange Grove, TX (US)

(21) Appl. No.: 19/061,359

(22) Filed: Feb. 24, 2025

(51) Int. Cl. B23P 19/04; F16K 3/02

(52) U.S. Cl. CPC B23P 19/047; F16K 3/0227

(57) ABSTRACT

In some implementations, a valve seat engagement tool for a valve seat having an inner diameter includes a mandrel having a tapered surface engaged with a collet element assembly having a corresponding tapered surface dimensioned to cooperate with the tapered surface of the mandrel to engage a valve seat within a valve body. A method of using the valve seat engagement tool is also disclosed.

### FIELD

Embodiments of the present principles generally relate to a valve seat extraction and installation tool. In particular a valve seat tool for use with a gate valve.

### BACKGROUND

Current gate valves are designed with a floating gate, wherein the seals are not actively biased against the gate. In floating gate valves, spaces or gaps exist between the surfaces of the gate and the valve seats. When pressurized during operation, the gate is pushed away from the inlet valve seat and towards the outlet valve seat if present, destroying the sealing contact between the valve seats and the gate. The floating gate design creates a gap between the gate and the valve seat. This gap between the gate and the valve seat allows fluids and solids to escape from the intended flowpath of the valve, typically entering the cavity of the valve body in which the gate is disposed. The leaking of fluid through the gap between the gate and the valve seat and into the valve body may remove necessary grease out of the valve body, resulting in accumulation of solids within the valve body, cause excessive damage to sealing and mechanical surfaces, and render the valve inoperable.

In addition, leaking of fluid through the gap between the gate and the valve seat and into the valve body may present significant safety issues, which may result in exposure of personnel to the chemicals flowing through the valve, as well as issues presented by malfunction or improper operation of the valve. The current “floating gate” design further requires constant maintenance and human interaction during operation in the field. There is a need to reduce or eliminate such safety concerns and human interaction related to gate valve operation in the field.

In a related application, the inventors have provided a gate valve, a gate valve system, and improved methods for reducing or eliminating the leaking of fluid through the gap between the gate and the valve seat and into the valve body of a gate valve. Utilization of this improved gate valve system requires the ability to bias the valve seat away from the gate to allow insertion of the gate into the valve, and also to remove the valve seat from the gate valve body. The inventors have discovered a valve seat tool for implementing the gate valve system, as well as other actions associated with a valve having a valve seat.

### SUMMARY

Embodiments of this disclosure relate to a valve seat tool. In particular, a valve seat tool suitable for use to install and extract a valve seat from a gate valve having a preloaded seat, wherein the valve seat or seats are biased against the gate. Embodiments further include a method of utilizing the valve seat tool to assemble and/or disassemble a gate valve having a preloaded seat, wherein the valve seats are actively biased against the gate.

In embodiments, a valve seat engagement tool for a valve seat having an inner diameter, comprises a mandrel having a first end having a tapered surface separated from a threaded end along a distance; a plurality of collet elements having a truncated triangular shape comprising an outer curved face, an inner tapered face, and two side faces disposed opposite one-another; the plurality of collet elements dimensioned and arranged such that when each of the plurality of collet elements are assembled side to side to form a collet element assembly, the outer curved faces form a discontinuous cylinder, and the inner tapered faces form a frustoconical shaped opening bound by the plurality of tapered faces having a taper dimensioned to cooperate with the tapered surface of the mandrel when disposed therethrough; the tapered surface of the mandrel and the inner tapered faces of the collet elements configured such that movement of the mandrel relative to the collet element assembly in a first direction causes the plurality of collet elements to expand radially outward and away from the mandrel such that the outer curved faces form a discontinuous cylindrical surface of the collet element assembly having a first expanded diameter, and movement of the mandrel relative to the collet element assembly in a second direction opposite the first direction allows the plurality of collet elements to contract radially inward toward the mandrel such that the outer curved faces form a discontinuous cylindrical surface of the collet element assembly having a second contracted diameter; a collet plate disposable around the mandrel and slidingly engageable with each of the plurality of collet elements, comprising a plurality of elongated slots disposed therethrough configured to slidingly engage a corresponding plurality of threaded members, each disposed through one of the elongated slots and engaged with one of the plurality of collet elements of the collet element assembly, the plurality of elongated slots dimensioned and arranged within the collet plate to maintain the collet element assembly in an expandable cylindrical arrangement; wherein the second contracted diameter is less than the inner diameter of the valve seat, and the first expanded diameter is larger than the inner diameter of the valve seat.

In embodiments, a method of using the valve seat engagement tool according to embodiments disclosed herein comprises disposing the collet assembly into the inner diameter of the valve seat; moving the mandrel relative to the collet element assembly in the first direction in an amount sufficient to engage the outer curved faces of the collet element assembly with the inner diameter of the valve seat to releasably engage the valve seat engagement tool with the valve seat.

### BRIEF DESCRIPTION OF THE DRAWINGS

Embodiments of the present principles, briefly summarized above and discussed in greater detail below, can be understood by reference to the illustrative embodiments of the principles depicted in the appended drawings. However, the appended drawings illustrate only typical embodiments of the principles and are thus not to be considered limiting of scope, for the principles may admit to other equally effective embodiments.

FIG. 1 depicts a cross-sectional view of a valve seat tool suitable for extraction in accordance with embodiments disclosed herein.

FIG. 2 depicts a frontal view of the valve seat tool shown in FIG. 1.

FIG. 3 depicts a perspective view of the valve seat tool shown in FIG. 1.

FIG. 4 depicts a side view of a mandrel of a valve seat tool in accordance with embodiments disclosed herein.

FIG. 5 depicts a cross-sectional view of the mandrel shown in FIG. 4.

FIG. 6 depicts a perspective view of the mandrel shown in FIG. 4.

FIG. 7 depicts a side view of a collet element assembly of a valve seat tool suitable for extraction in according to embodiments disclosed herein.

FIG. 8 shows a side view of the collet element assembly shown in FIG. 7.

FIG. 9 depicts a collet plate of a valve seat tool in accordance with embodiments disclosed herein.

FIG. 10 is a perspective view of the collet plate shown in FIG. 9.

FIG. 11 is an exploded view of a valve seat tool suitable for extraction in accordance with embodiments disclosed herein.

FIG. 12 depicts an overhead view of a removal biscuit in accordance with embodiments disclosed herein.

FIG. 13 is a cross-sectional view of the removal biscuit shown in FIG. 12.

FIG. 14 is a perspective view of the removal biscuit shown in FIG. 12.

FIG. 15 is coupling nut in accordance with embodiments disclosed herein.

FIG. 16 depicts a perspective view of a valve body of a gate valve, equipped with a valve seat tool suitable for extraction in accordance with embodiments disclosed herein.

FIG. 17 is a cross-sectional view of the valve body of the gate valve equipped with a valve seat tool suitable for extraction shown in FIG. 16.

FIG. 18 is an exploded view depicting a valve seat tool suitable for installation of a biased valve seat in accordance with embodiments disclosed herein.

FIG. 19 depicts a perspective view of a valve body of a gate valve, equipped with a valve seat tool suitable for installation of a biased valve seat in accordance with embodiments disclosed herein.

FIG. 20 is a cross-sectional view of the valve body of the gate valve equipped with two valve seat tools suitable for installation of biased valve seats shown in FIG. 19.

### DETAILED DESCRIPTION

The embodiments of this disclosure relate to a valve seat tool. In some embodiments, the valve seat tool is suitable for use in assembling a gate valve having a preloaded valve seat, wherein the valve seat is biased against the gate via a compressible seal disposed between the valve body and the valve seat. Other embodiments disclosed herein relate to a valve seat tool suitable for extraction of a valve seat from a gate valve body, which typically requires additional force to remove once the valve seat has been in operation for a period of time. While the mechanism by which both the valve seat tool suitable for valve assembly and the valve seat tool suitable for extraction are the same, the valve seat tool suitable for extraction has additional support and is more rugged in construction relative to the valve seat tool suitable for assembly. However, either one or both of the embodiments may be utilized depending on the requirements and end use.

For purposes herein, the valve seat engagement tool is also referred to herein as a valve seat tool, or simply as a “tool”.

For purposes herein, a valve seat tool suitable for use in assembling a gate valve having a preloaded valve seat is referred to herein as an assembly tool. Likewise, a valve seat tool suitable for use in removing a valve seat from a gate valve, e.g., disassembling a gate valve, is referred to herein as a removal tool. Various components of the assembly tool and the removal tool are interchangeable. As such, interchangeable components are referred to as being part of a seat engagement tool, a valve seat tool, or simply as a part of “tool”.

As noted herein, current “floating gate” designs of gate valves require constant maintenance and human interaction during operation in the field. There is a need to reduce or eliminate such safety concerns and human interaction related to gate valve operation in the field. Gate valves, systems, and methods according to embodiments disclosed in a related patent application utilize a pre-loaded valve seat, comprising oversized seals i.e., compressible seals located between the valve body and the valve seat, which are compressed before valve assembly. This is accomplished using a seat engagement tool according to embodiments disclosed herein. This seat engagement tool may be powered mechanically and/or hydraulically, and may be utilized to disassemble, and/or assemble a gate valve according to embodiments disclosed herein. Once the gate valve is assembled, the pressure is released from the seat engagement tool and the seat engagement tool is removed from the gate valve. The valve seats are retained within the gate valve with the compressible seals compressed and in a pre-loaded or energized state. However, installation of a pre-loaded valve seat system requires being able to bias the valve seat away from the gate valve. This presents significant limitations on the size of the assembly tool, since the gate valve must be equipped with two assembly tools, one on each side of the gave valve, and both must be operational to bias the valve seat away from the valve body, but cannot interfere with the insertion of the sliding gate, and cannot damage the machined surfaces of the valve seat.

Likewise, when retrofitting a gate valve to include a pre-loaded valve seat, a previously used valve seat must be removed. Also, a pre-loaded valve seat must be removed from time to time to either replace a fatigued valve seal, or during normal maintenance of the gate valve. It has been observed by the inventors that removal of a valve seat from a valve often requires significantly more force than is required to install a pre-loaded valve seat system. In addition, removal of a valve seat allows for access on both an inlet side and an outlet side of the valve body, thereby allowing for additional components suitable for removal of a valve seat from a valve body.

Gate valves known in the art which are designed with removeable seats have a common problem after assembly. Once assembled, and especially after use, the seats often become very difficult to remove. There are no features on valve seats that allow for a tool to engage the valve seat and be used to aid in removal. Embodiments disclosed herein include a seat engagement tool, e.g., a removal tool, which includes an expanding mandrel/collet design which allows the engagement tool to engage a smooth outside diameter for optimal surface contact when expanded against the internal diameter of the valve seat i.e., the inner-flowpath of the valve seat.

The seat engagement tool is operable to produce a contact pressure between the seat engagement tool and the valve seat which is greater than the force holding the valve seat in the valve body. The removal tool may then be engaged with a hydraulic ram/cylinder and once hydraulic pressure is applied; the removal tool will extract the valve seat from the valve body.

Without utilizing the seat engagement tool, the common options for seat removal in the art have been blunt force using hammers and chisels and/or gas cutting torch. Either of these methods damage the seat beyond use and in extreme cases damage can occur to the valve body. Seats and valve bodies are infinitely reusable when not severely damaged, thereby conserving resources. Accordingly, the removal tool allows for removal of a valve seat, which may then be machined and otherwise configured to be used with an oversized seal consistent with a pre-loaded valve seat. The assembly tool may then be employed to reassemble the valve, retrofitted with pre-loaded valve seats.

In embodiments, a valve seat engagement tool for a valve seat having an inner diameter, comprising: a mandrel having a first end having a tapered surface separated from a threaded end along a distance; a plurality of collet elements having a truncated triangular shape comprising an outer curved face, an inner tapered face, and two side faces disposed opposite one-another; the plurality of collet elements dimensioned and arranged such that when each of the plurality of collet elements are assembled side to side to form a collet element assembly, the outer curved faces form a discontinuous cylinder, and the inner tapered faces form a frustoconical shaped opening bound by the plurality of tapered faces having a taper dimensioned to cooperate with the tapered surface of the mandrel when disposed therethrough; the tapered surface of the mandrel and the inner tapered faces of the collet elements configured such that movement of the mandrel relative to the collet element assembly in a first direction causes the plurality of collet elements to expand radially outward and away from the mandrel such that the outer curved faces form a discontinuous cylindrical surface of the collet element assembly having a first expanded diameter, and movement of the mandrel relative to the collet element assembly in a second direction opposite the first direction allows the plurality of collet elements to contract radially inward toward the mandrel such that the outer curved faces form a discontinuous cylindrical surface of the collet element assembly having a second contracted diameter; a collet plate disposable around the mandrel and slidingly engageable with each of the plurality of collet elements, comprising a plurality of elongated slots disposed therethrough configured to slidingly engage a corresponding plurality of threaded members, each disposed through one of the elongated slots and engaged with one of the plurality of collet elements of the collet element assembly, the plurality of elongated slots dimensioned and arranged within the collet plate to maintain the collet element assembly in an expandable cylindrical arrangement; wherein the second contracted diameter is less than the inner diameter of the valve seat, and the first expanded diameter is larger than the inner diameter of the valve seat.

In some embodiments, the valve seat engagement tool further comprises a threaded hole disposed into the first end of the mandrel oriented along a center axis of the mandrel, sized to engage a threaded removal stud which extends away from the first end along the center axis; a removal biscuit disposable about the removal stud having an outer cylindrical shape with a center hole disposed there through; the cylindrical shape having an outer diameter larger than an outer diameter of the first end of the mandrel, an essentially flat upper face, and a stepped lower face; the stepped lower face of the removal biscuit having an outer portion engageable with a corresponding face of each of the plurality of assembled collet elements, and an inner portion comprising a cylindrical depression disposed into the stepped lower face, bounded by the outer portion and having an inner diameter greater than or equal to the outer diameter of the first end of the mandrel; the removal biscuit arranged such that when disposed about the removal stud wherein the outer portion of the inner face is engaged with the collet assembly, movement of an outer end of the removal stud away from the upper face of the removal biscuit causes movement of the mandrel relative to the collet assembly in the second direction, allowing the plurality of collet elements to contract radially inward toward the mandrel, and a portion of the mandrel first end to protrude into the inner portion of the stepped lower face of the removal biscuit.

In embodiments, the removal stud is engaged with the upper face of the removal biscuit via a nut engaged with the upper face of the removal biscuit and threadedly engaged with the removal stud. In embodiments, the valve seat engagement tool further comprises two collet plates, each disposed on opposite sides of the plurality of the collet assembly. In embodiments, the valve seat engagement tool further comprises a coupling configured to engage the threaded end of the mandrel on one side, and a threaded portion of an extension rod.

In embodiments, the valve seat engagement tool further comprises a hydraulic piston assembly, engageable about the threaded end of the mandrel, or an extension engaged with the threaded end of the mandrel, configured to be located external to a valve body in which the valve seat is disposed, and provide movement of the mandrel relative to the collet element assembly in the first direction.

In embodiments, a method of using the valve seat engagement tool according to one or more embodiments disclosed herein comprises disposing the collet assembly into the inner diameter of the valve seat; moving the mandrel relative to the collet element assembly in the first direction in an amount sufficient to engage the outer curved faces of the collet element assembly with the inner diameter of the valve seat to releasably engage the valve seat engagement tool with the valve seat.

In embodiments of the method, the valve seat is disposed within a valve body, and the method further comprises movement of the mandrel relative to the valve body to compress a seal located between the valve body and the valve seat.

In embodiments, the moving of the mandrel comprises the use of a hydraulic cylinder located external to the valve body and directly or indirectly engaged with the threaded end of the mandrel.

In embodiments, the method further comprises moving the mandrel relative to the collet element assembly in the second direction in an amount sufficient to disengage the valve seat engagement tool from the valve seat.

In embodiments of the method, the moving of the mandrel in the second direction comprises one or more hammer blows directly or indirectly to the threaded end of the mandrel.

In embodiments a method of using a valve seat engagement tool according to embodiments disclosed herein comprises disposing the collet assembly into the inner diameter of the valve seat; moving the mandrel relative to the collet element assembly in the first direction in an amount sufficient to engage the outer curved faces of the collet element assembly with the inner diameter of the valve seat to releasably engage the valve seat engagement tool with the valve seat.

In embodiments, the valve seat is disposed within a valve seat mounting portion of a valve body, and further comprising movement of the mandrel relative to the valve body to remove the valve seat from the valve seat mounting portion of the valve body.

In embodiments, the moving of the mandrel comprises the use of a hydraulic cylinder located external to the valve body and directly or indirectly engaged with the threaded end of the mandrel.

In embodiments, the method further comprises moving the outer end of the removal stud away from the upper face of the removal biscuit in an amount sufficient to disengage the valve seat engagement tool from the valve seat.

In embodiments the moving of the outer end of the removal stud away from the upper face of the removal biscuit comprises one or more hammer blows directly or indirectly to the threaded end of the mandrel.

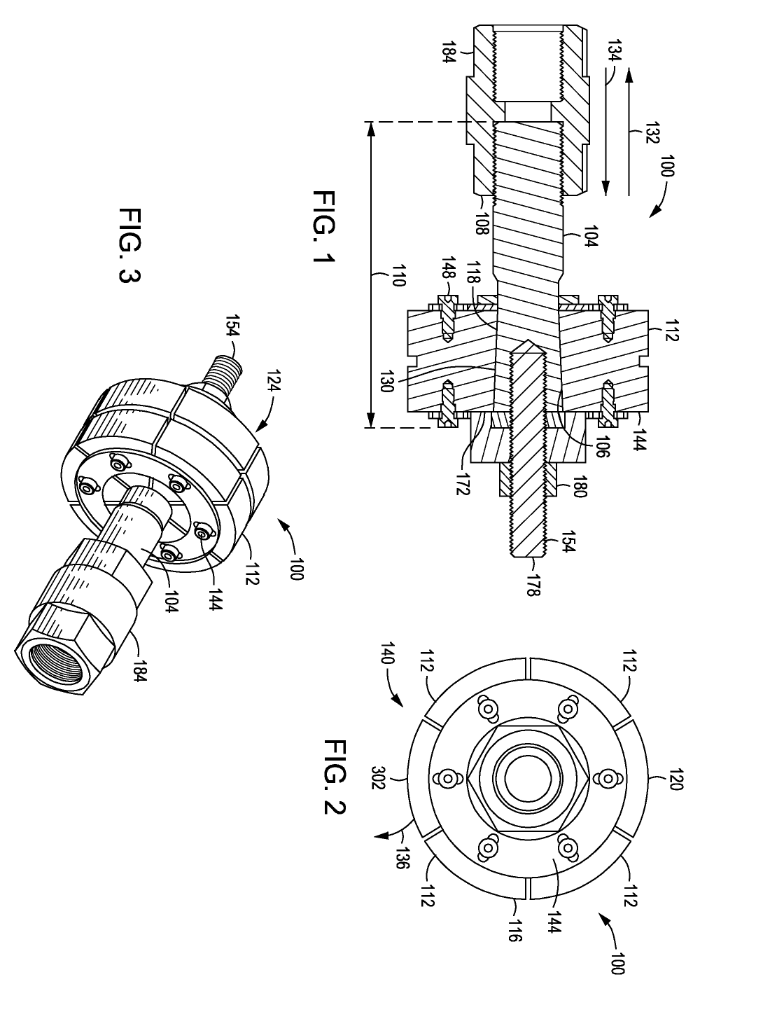

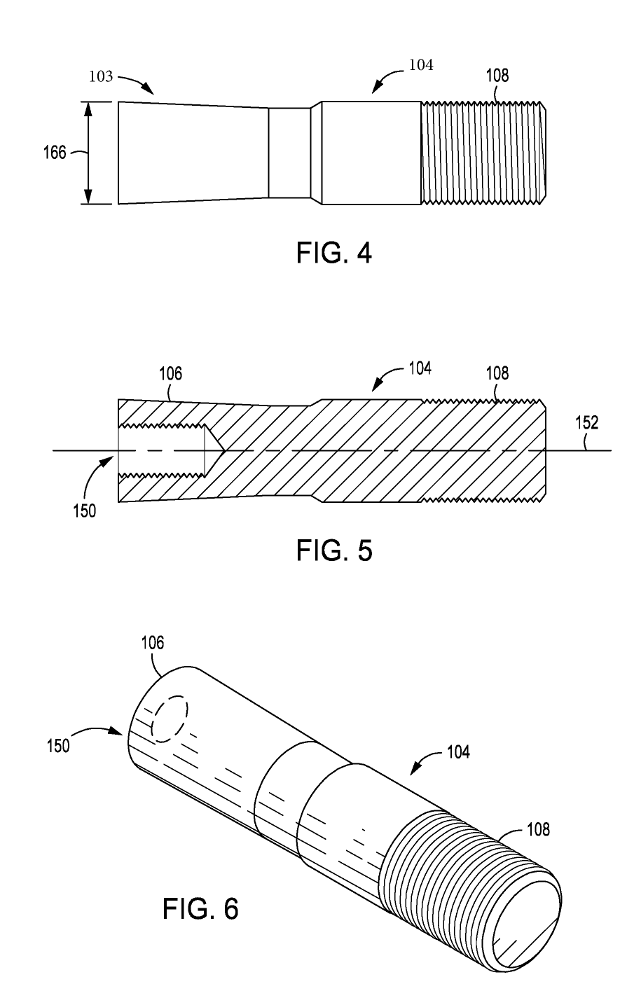

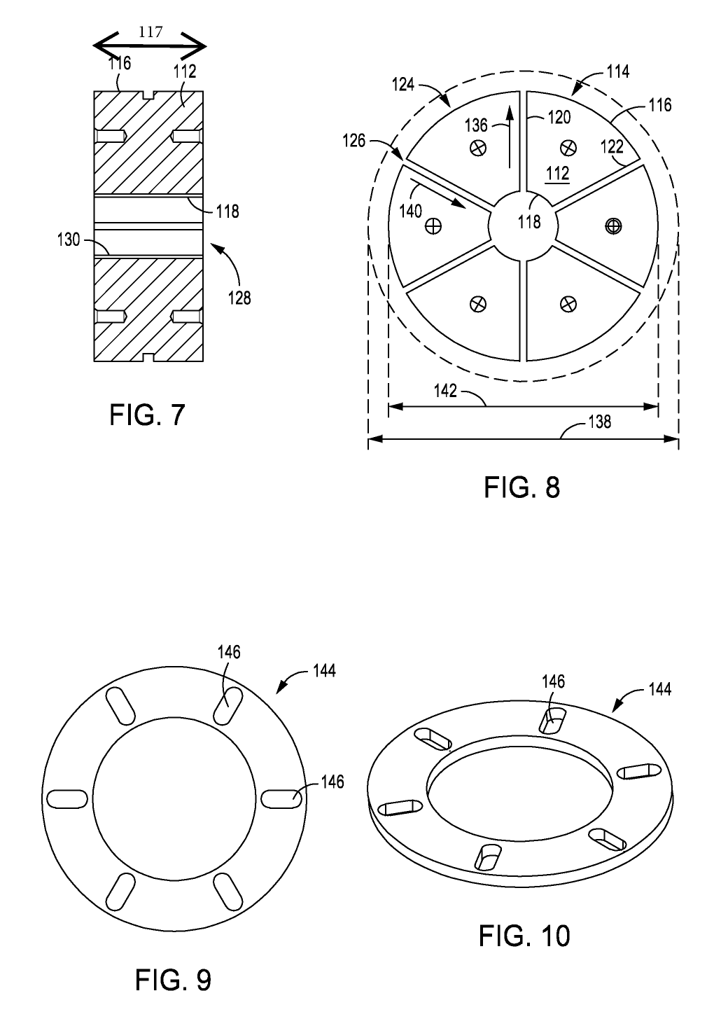

Turning now to the figures, wherein FIG. 1, depicts a cross-sectional view of a valve seat tool 100 suitable for extraction in accordance with embodiments disclosed herein; FIG. 2 depicts a frontal view of the valve seat tool 100 shown in FIG. 1; FIG. 3 depicts a perspective view of the valve seat tool 100 shown in FIG. 1; FIG. 4 depicts a side view of a mandrel of a valve seat tool in accordance with embodiments disclosed herein; FIG. 5 depicts a cross-sectional view of the mandrel shown in FIG. 4; FIG. 6 depicts a perspective view of the mandrel shown in FIG. 4; FIG. 7 depicts a side view of a collet element assembly of a valve seat tool suitable for extraction in according to embodiments disclosed herein; and FIG. 8 shows a side view of the collet element assembly shown in FIG. 7, the valve seat tool 100 is suitable for use with a valve seat 182 having an inner diameter 102 (see FIG. 17). The valve seat tool 100 includes a mandrel 104 having a first end 103 comprising a tapered surface 106 separated from a threaded end 108 along a distance 110, e.g., a length. As shown in FIGS. 7 and 8, the valve seat tool 100 further includes a plurality of collet elements 112 having a truncated triangular shape 114 comprising an outer curved face 116, an inner tapered face 118, and two side faces e.g., a first side face 120 and a second side face 122 disposed opposite one another. The plurality of collet elements 112 are dimensioned and arranged such that when each of the plurality of collet elements 112 are assembled side to side to form a collet element assembly 124, the outer curved faces 116 form a discontinuous cylindrical surface 126, and the inner tapered faces 118 form a frustoconical shaped opening 128 bound by the plurality of inner tapered faces 118 having a taper angle 130 dimensioned to cooperate with a corresponding taper angle present on the tapered surface 106 of the mandrel 104 when disposed therethrough as shown in FIG. 1.

The tapered surface 106 of the mandrel 104, and the inner tapered faces 118 of the collet elements 112 are configured such that movement of the mandrel 104 relative to the collet element assembly 124 in a first direction 132 causes the plurality of collet elements 112 to expand radially outward 136 and away from the mandrel 104 such that the outer curved faces 116 form a discontinuous cylindrical surface 126 of the collet element assembly 124 having a first expanded diameter 138, and movement of the mandrel 104 relative to the collet element assembly 124 in a second direction 134 opposite the first direction 132 allows the plurality of collet elements 112 to contract radially inward 140 toward the mandrel 104 such that the outer curved faces 116 form a discontinuous cylindrical surface 126 of the collet element assembly 124 having a second contracted diameter 142. The arrangement of the tapered surface 106 of the mandrel 104 and the inner tapered faces 118 of the collet elements 112 is known in the art to be a cooperative taper configuration. The second contracted diameter 142 is less than the inner diameter 102 of the valve seat 182 (see FIG. 17), and the first expanded diameter 138 is larger than the inner diameter 102 of the valve seat 182 (see FIG. 17). In embodiments, a taper percentage of the taper present on the tapered surface 106 of the mandrel 104 and the inner tapered faces 118 of the collet elements 112, when determined as the change in diameter of the tapered surface 106 of the mandrel shaft per unit of longitudinal distance along the main axis of the tapered surface 106 of the mandrel shaft, is from about 0.5% to 7.5%, or from about 0.75% to 5%, or from about 1% to 4.5%. Accordingly, in embodiments, the tapered surface 106 of the mandrel 104 has a percent taper from about 0.5% to 7.5%.

In embodiments, the outer curved faces 116 of the collet element assembly 124 are configured to engage an inner-flowpath 121 of the valve seat 182 (see FIG. 17), which is coaxially disposed about a fluid passage disposed between two ends of the valve seat 182. Accordingly, the inner-flowpath 121 of the valve seat is typically equal to a valve seat length 119. In embodiments, the outer curved faces 116 have a thickness 117 (see FIG. 7) disposed parallel to the axis of the mandrel 104, which is dimensioned and arranged to releasably engage at least about 50% of the valve seat length 119, or at least about 70% of the valve seat length 119, or at least about 95% of the valve seat length 119. In embodiments, the thickness 117 of the outer curved faces 116 of the collet element assembly 124 is greater than the valve seat length 119.

In embodiments, the outer curved faces 116 of the collet element assembly 124 which engages the inner-flowpath 121 of the valve seat 182 are relatively smooth, such that engagement of the inner-flowpath 121 of the valve seat 182 by the collet element assembly 124 does not adversely affect the inner-flowpath 121, e.g., does not result in marring of the surface of the inner-flowpath 121.

Accordingly, in embodiments, the outer curved faces have a thickness disposed parallel to an axis of the mandrel, which is dimensioned and arranged to releasably engage at least about 50% of a length of the inner diameter of the valve seat.

In embodiments, the valve seat tool 100 further includes a collet plate 144 disposable around the mandrel 104 and slidingly engageable with each of the plurality of collet elements 112. FIG. 9 depicts a collet plate of a valve seat tool 100 in accordance with embodiments disclosed herein and FIG. 10 is a perspective view of the collet plate shown in FIG. 9. As shown in FIGS. 9 and 10, the collet plate 144 comprising a plurality of elongated slots 146 disposed therethrough configured to slidingly engage a corresponding plurality of threaded members 148, each disposed through one of the elongated slots 146 and engaged with one of the plurality of collet elements 112 of the collet element assembly 124. The plurality of elongated slots 146 are dimensioned and arranged within the collet plate 144 to maintain the collet element assembly 124 in an expandable cylindrical arrangement.

As shown in FIG. 5, a threaded hole 150 may be disposed into the first end of the mandrel 104 oriented along a center axis 152 of the mandrel 104. The threaded hole 150 is sized to engage a threaded removal stud 154 which extends away from the first end along the center axis 152.

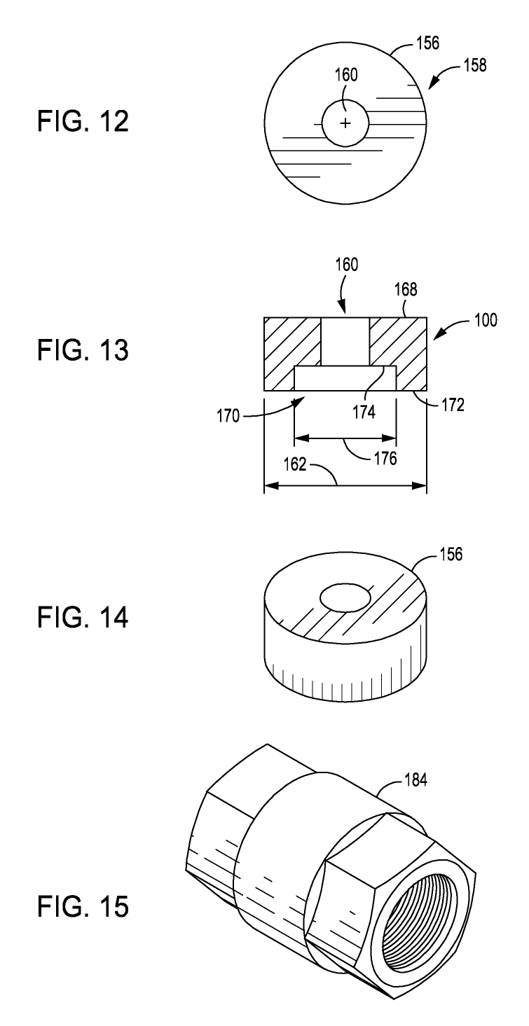

FIG. 12 depicts an overhead view of a removal biscuit in accordance with embodiments disclosed herein; FIG. 13, which is a cross-sectional view of the removal biscuit shown in FIG. 12; and FIG. 14, which is a perspective view of the removal biscuit shown in FIG. 12. The removal biscuit 156 is disposed about the removal stud 154 and having an outer cylindrical shape 158 with a center hole 160 disposed there through. The cylindrical shape 158 has an outer diameter 162 which is larger than an outer diameter 166 of the end proximate to the tapered surface 106 of the mandrel 104 (See FIG. 4). The removal biscuit 156 may have an essentially flat upper face 168, and a stepped lower face 170. The stepped lower face 170 of the removal biscuit 156 has an outer portion 172 engageable with a corresponding face of each of the plurality of assembled collet elements 112, and an inner portion 174 comprising a cylindrical depression disposed into the stepped lower face 170, bounded by the outer portion 172 and having an inner diameter 176 which is greater than or equal to the outer diameter 166 of the end proximate to the tapered surface 106 of the mandrel 104. The removal biscuit 165 is arranged such that when disposed about the removal stud 154, wherein the outer portion 172 of the inner face is engaged with the collet element assembly 124, movement of an outer end 178 of the removal stud 154 away from the upper face 168 of the removal biscuit 156, e.g., via loosening of an adjustment nut 180 on the removal stud 154, causes relative movement of the mandrel 104 relative to the collet element assembly 124 in the second direction 134, allowing the plurality of collet elements 112 to contract radially inward 140 toward the mandrel 104, and a portion of the first end 103 of the mandrel 104 to protrude into the inner portion 174 of the stepped lower face 170 of the removal biscuit 156. Likewise, movement of the outer end 178 of the removal stud 154 toward the upper face 168 of the removal biscuit 156, e.g., via tightening of the adjustment nut 180 on the removal stud 154, causes relative movement of the mandrel 104 relative to the collet element assembly 124 in the first direction 132, causing the plurality of collet elements 112 to radially expand outward 136 away from the mandrel 104, and a portion of the first end 103 of the mandrel 104 to be removed from the inner portion 174 of the stepped lower face 170 of the removal biscuit 156, which may be used to secure the valve seat tool 100 within a valve seat 182.

In embodiments, the removal stud 154 is engaged with the upper face 168 of the removal biscuit 156 via an adjustment nut 180 engaged with the upper face 168 of the removal biscuit 156 and threadedly engaged with the removal stud 154.

In embodiments, the valve seat tool 100 comprises two collet plates 144, each disposed on opposite sides of the collet element assembly 124.

In embodiments, the valve seat tool 100 further comprises a coupling 184 as shown in FIG. 15, configured to engage the threaded end 108 of the mandrel 104 on one side, and a threaded portion of an extension rod 186 (see FIG. 17).

In embodiments, the valve seat tool 100 further comprises a hydraulic cylinder 188 (see FIG. 17 and FIG. 20), engageable about the threaded end 108 of the mandrel 104 (see FIG. 20), or an extension rod 186 (see FIG. 17) engaged with the threaded end 108 of the mandrel 104, e.g., via coupling 184, configured to be located external to a valve body 190 in which the valve seat 182 is disposed. The hydraulic cylinder (hydraulic piston assembly) 188 is configured to provide movement of the mandrel 104 relative to the collet element assembly 124 in the first direction 132.

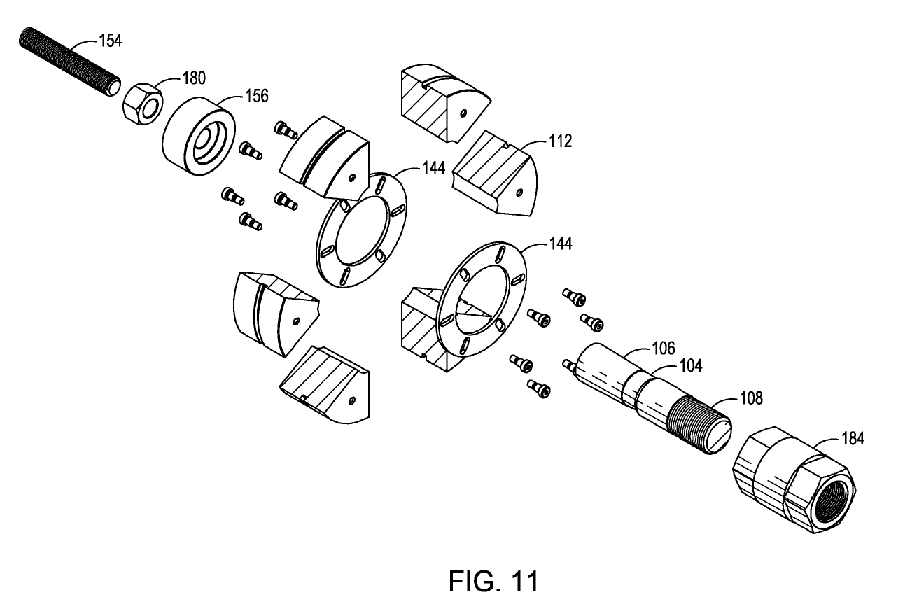

FIG. 11 is an exploded view of a valve seat tool suitable for extraction of the valve seat, e.g., a removal tool 101 in accordance with embodiments disclosed herein.

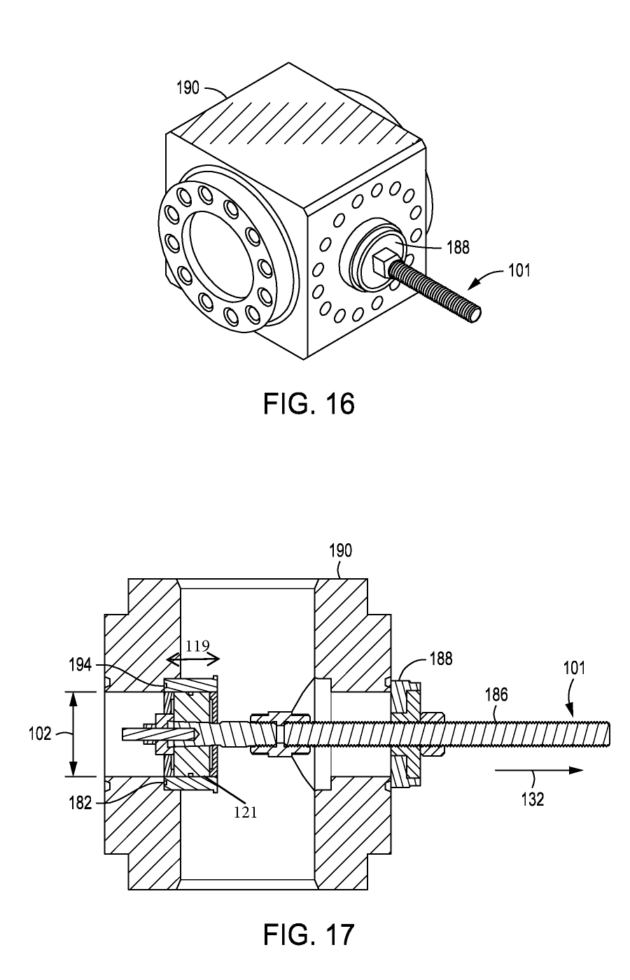

FIG. 16 depicts a perspective view of a valve body 190 of a gate valve, equipped with a removal tool 101 in accordance with embodiments disclosed herein.

FIG. 17 is a cross-sectional view of the valve body 190 of the gate valve equipped with the removal tool 101, engaged with a valve seat 182.

Removal of the valve seat 182 allows for access of both an inlet and outlet side of the valve body 190.

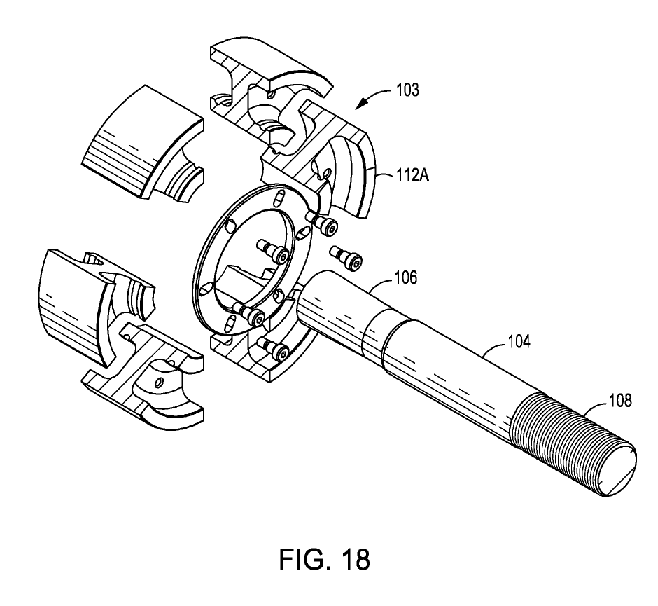

FIG. 18 is an exploded view depicting a valve seat tool suitable for installation of a biased valve seat e.g., an assembly tool 103 in accordance with embodiments disclosed herein. The assembly tool 103 shares the same or similar components e.g., the mandrel 104, and the collet plate 144 as the removal tool. In embodiments, the assembly tool 103 has a single collet plate 144.

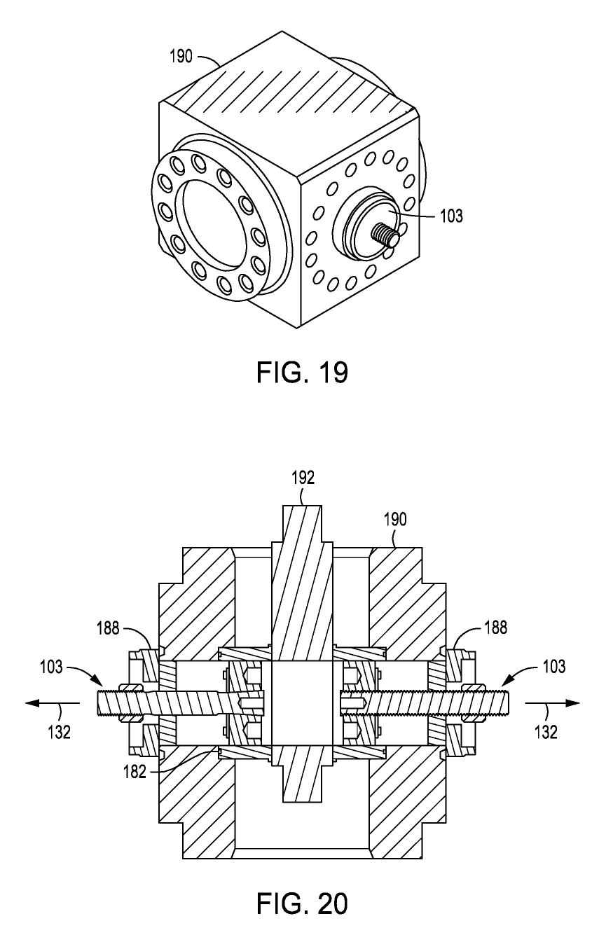

FIG. 19 depicts a perspective view of a valve body 190 of a gate valve equipped with a valve seat tool suitable for installation of a biased valve seat, e.g., and assembly tool 103 in accordance with embodiments disclosed herein.

As shown in FIG. 20, a pair of assembly tools 103 may be used. The assembly tool 103 may not have the removal stud 154, or the removal biscuit 156. As shown in FIG. 20, the assembly tool 103 must fit within the valve seat 182 and be engaged to bias the valve seat 182 against the valve body 190, e.g., by movement in the first direction 132, thereby allowing insertion of the gate slide 192 during assembly of the valve.

In embodiments, a method of using the valve seat tool 100 comprising disposing the collet element assembly 124 into the inner diameter 102 of the valve seat 182, and moving the mandrel 104 relative to the collet element assembly 124 in the first direction 132 in an amount sufficient to engage the outer curved faces 116 of the collet element assembly 124 with the inner diameter 102 of the valve seat 182 to releasably engage the valve seat tool 100 with the valve seat 182. In embodiments, the valve seat 182 is disposed within a valve body 190, and the method further comprises movement of the mandrel 104 relative to the valve body 190 to compress a seal 194 (shown in FIG. 20) located between the valve body 190 and the valve seat 182.

In embodiments, the moving of the mandrel 104 comprises the use of a hydraulic cylinder 188 located external to the valve body and directly or indirectly engaged with the threaded end 108 of the mandrel 104. In embodiments, the method includes moving the mandrel 104 relative to the collet element assembly 124 in the second direction 134 in an amount sufficient to disengage the valve seat tool 100 from the valve seat 182. In some of such embodiments, the moving of the mandrel 104 in the second direction 134 comprises one or more hammer blows (not shown) directly or indirectly to the threaded end 108 of the mandrel 104.

In embodiments, the valve seat tool 100 is utilized by disposing the collet element assembly 124 into the inner diameter 102 of the valve seat 182 and moving the mandrel 104 relative to the collet element assembly 124 in the first direction 132 in an amount sufficient to engage the outer curved faces 116 of the collet element assembly 124 with the inner diameter 102 of the valve seat 182 to releasably engage the valve seat tool 100 with the valve seat 182. In embodiments, the valve seat 182 is disposed within a valve seat mounting portion of a valve body 190, and the method further comprises movement of the mandrel 104 relative to the valve body 190 to remove the valve seat 182 from the valve seat mounting portion of the valve body 190, which in embodiments, includes employing a hydraulic cylinder 188 located external to the valve body 190 which is directly or indirectly engaged with the threaded end 108 of the mandrel 104.

In embodiments, the moving the outer end 178 of the removal stud 154 away from the upper face 168 of the removal biscuit 156 disengages the valve seat tool 100 from the valve seat 182.

### EMBODIMENTS

The instant disclosure includes but is not limited to the following embodiments.

E1. A valve seat engagement tool for a valve seat having an inner diameter, comprising:

a mandrel having a first end comprising a tapered surface separated from a threaded end along a distance;

a plurality of collet elements having a truncated triangular shape comprising an outer curved face, an inner tapered face, and two side faces disposed opposite one-another;

the plurality of collet elements dimensioned and arranged such that when each of the plurality of collet elements are assembled side to side to form a collet element assembly, the outer curved faces form a discontinuous cylinder, and the inner tapered faces form a frustoconical shaped opening bound by the plurality of tapered faces having a taper dimensioned to cooperate with the tapered surface of the mandrel when disposed therethrough;

the tapered surface of the mandrel and the inner tapered faces of the collet elements configured such that movement of the mandrel relative to the collet element assembly in a first direction causes the plurality of collet elements to expand radially outward and away from the mandrel such that the outer curved faces form a discontinuous cylindrical surface of the collet element assembly having a first expanded diameter, and

movement of the mandrel relative to the collet element assembly in a second direction opposite the first direction allows the plurality of collet elements to contract radially inward toward the mandrel such that the outer curved faces form a discontinuous cylindrical surface of the collet element assembly having a second contracted diameter;

a collet plate disposable around the mandrel and slidingly engageable with each of the plurality of collet elements, comprising a plurality of elongated slots disposed therethrough configured to slidingly engage a corresponding plurality of threaded members, each disposed through one of the elongated slots and engaged with one of the plurality of collet elements of the collet element assembly, the plurality of elongated slots dimensioned and arranged within the collet plate to maintain the collet element assembly in an expandable cylindrical arrangement;

wherein the second contracted diameter is less than the inner diameter of the valve seat, and the first expanded diameter is larger than the inner diameter of the valve seat.

E2. The valve seat engagement tool according to embodiment E1, further comprising:

a threaded hole disposed into the first end of the mandrel oriented along a center axis of the mandrel, sized to engage a threaded removal stud which extends away from the first end along the center axis;

a removal biscuit disposable about the removal stud having an outer cylindrical shape with a center hole disposed there through;

the cylindrical shape having an outer diameter larger than an outer diameter of the first end of the mandrel, an essentially flat upper face, and a stepped lower face;

the stepped lower face of the removal biscuit having an outer portion engageable with a corresponding face of each of the plurality of assembled collet elements, and an inner portion comprising a cylindrical depression disposed into the stepped lower face, bounded by the outer portion and having an inner diameter greater than or equal to the outer diameter of the first end of the mandrel;

the removal biscuit arranged such that when disposed about the removal stud wherein the outer portion of the inner face is engaged with the collet assembly, movement of an outer end of the removal stud away from the upper face of the removal biscuit causes movement of the mandrel relative to the collet assembly in the second direction, allowing the plurality of collet elements to contract radially inward toward the mandrel, and a portion of the mandrel first end to protrude into the inner portion of the stepped lower face of the removal biscuit.

E3. The valve seat engagement tool according to embodiment E2, wherein the removal stud is engaged with the upper face of the removal biscuit via a nut engaged with the upper face of the removal biscuit and threadedly engaged with the removal stud.

E4. The valve seat engagement tool according to embodiments E1 through E3, comprising two collet plates, each disposed on opposite sides of the collet element assembly.

E5. The valve seat engagement tool according to embodiments E1 through E4, further comprising a coupling configured to engage the threaded end of the mandrel on one side, and a threaded portion of an extension rod.

E6. The valve seat engagement tool according to embodiments E1 through E5, further comprising a hydraulic piston assembly, engageable about the threaded end of the mandrel, or an extension engaged with the threaded end of the mandrel, configured to be located external to a valve body in which the valve seat is disposed, and provide movement of the mandrel relative to the collet element assembly in the first direction.

E7. The valve seat engagement tool according to embodiments E1 through E6, wherein the tapered surface of the mandrel has a percent taper from about 0.5% to 7.5%.

E8. The valve seat engagement tool according to embodiments E1 through E7, wherein the outer curved faces have a thickness disposed parallel to an axis of the mandrel, which is dimensioned and arranged to releasably engage at least about 50% of a length of the inner diameter of the valve seat.

E9. A method of using the valve seat engagement tool according to embodiments E1 through E8, comprising:

disposing the collet assembly into the inner diameter of the valve seat;

moving the mandrel relative to the collet element assembly in the first direction in an amount sufficient to engage the outer curved faces of the collet element assembly with the inner diameter of the valve seat to releasably engage the valve seat engagement tool with the valve seat.

E10. The method according to embodiment E9, wherein the valve seat is disposed within a valve body, and further comprising movement of the mandrel relative to the valve body to compress a seal located between the valve body and the valve seat.

E11. The method according to embodiments E9 through E10, wherein the moving of the mandrel comprises the use of a hydraulic cylinder located external to the valve body and directly or indirectly engaged with the threaded end of the mandrel.

E12. The method according to embodiments E9 through E11, further comprising moving the mandrel relative to the collet element assembly in the second direction in an amount sufficient to disengage the valve seat engagement tool from the valve seat.

E13. The method according to embodiments E9 through E12, wherein the moving of the mandrel in the second direction comprises one or more hammer blows directly or indirectly to the threaded end of the mandrel.

E14. The method according to embodiments E9 through E13, further comprising:

disposing the collet assembly into the inner diameter of the valve seat;

moving the mandrel relative to the collet element assembly in the first direction in an amount sufficient to engage the outer curved faces of the collet element assembly with the inner diameter of the valve seat to releasably engage the valve seat engagement tool with the valve seat.

E15. The method according to embodiments E9 through E14, wherein the valve seat is disposed within a valve seat mounting portion of a valve body, and further comprising movement of the mandrel relative to the valve body to remove the valve seat from the valve seat mounting portion of the valve body.

E16. The method according to embodiments E9 through E153, wherein the moving of the mandrel comprises the use of a hydraulic cylinder located external to the valve body and directly or indirectly engaged with the threaded end of the mandrel.

moving the outer end of the removal stud away from the upper face of the removal biscuit in an amount sufficient to disengage the valve seat engagement tool from the valve seat.

E17. The method according to embodiments E9 through E16, further comprising:

While the foregoing is directed to embodiments of the present principles, other and further embodiments of the principles may be devised without departing from the basic scope thereof.

What is claimed is:

1. A valve seat engagement tool for a valve seat having an inner diameter, comprising:
a mandrel having a first end comprising a tapered surface separated from a threaded end along a distance;
a plurality of collet elements having a truncated triangular shape comprising an outer curved face, an inner tapered face, and two side faces disposed opposite one-another;
the plurality of collet elements dimensioned and arranged such that when each of the plurality of collet elements are assembled side to side to form a collet element assembly, the outer curved faces form a discontinuous cylinder, and the inner tapered faces form a frustoconical shaped opening bound by the plurality of tapered faces having a taper dimensioned to cooperate with the tapered surface of the mandrel when disposed therethrough;
the tapered surface of the mandrel and the inner tapered faces of the collet elements configured such that movement of the mandrel relative to the collet element assembly in a first direction causes the plurality of collet elements to expand radially outward and away from the mandrel such that the outer curved faces form a discontinuous cylindrical surface of the collet element assembly having a first expanded diameter; and
movement of the mandrel relative to the collet element assembly in a second direction opposite the first direction allows the plurality of collet elements to contract radially inward toward the mandrel such that the outer curved faces form a discontinuous cylindrical surface of the collet element assembly having a second contracted diameter;
a collet plate disposable around the mandrel and slidingly engageable with each of the plurality of collet elements, comprising a plurality of elongated slots disposed therethrough configured to slidingly engage a corresponding plurality of threaded members, each disposed through one of the elongated slots and engaged with one of the plurality of collet elements of the collet element assembly, the plurality of elongated slots dimensioned and arranged within the collet plate to maintain the collet element assembly in an expandable cylindrical arrangement;
wherein the second contracted diameter is less than the inner diameter of the valve seat, and the first expanded diameter is larger than the inner diameter of the valve seat.

2. The valve seat engagement tool of claim 1, further comprising:
a threaded hole disposed into the first end of the mandrel oriented along a center axis of the mandrel, sized to engage a threaded removal stud which extends away from the first end along the center axis;
a removal biscuit disposable about the removal stud having an outer cylindrical shape with a center hole disposed there through;
the cylindrical shape having an outer diameter larger than an outer diameter of the first end of the mandrel, an essentially flat upper face, and a stepped lower face;
the stepped lower face of the removal biscuit having an outer portion engageable with a corresponding face of each of the plurality of assembled collet elements, and an inner portion comprising a cylindrical depression disposed into the stepped lower face, bounded by the outer portion and having an inner diameter greater than or equal to the outer diameter of the first end of the mandrel;
the removal biscuit arranged such that when disposed about the removal stud wherein the outer portion of the inner face is engaged with the collet assembly, movement of an outer end of the removal stud away from the upper face of the removal biscuit causes movement of the mandrel relative to the collet assembly in the second direction, allowing the plurality of collet elements to contract radially inward toward the mandrel, and a portion of the mandrel first end to protrude into the inner portion of the stepped lower face of the removal biscuit.

3. The valve seat engagement tool of claim 2, wherein the removal stud is engaged with the upper face of the removal biscuit via a nut engaged with the upper face of the removal biscuit and threadedly engaged with the removal stud.

4. The valve seat engagement tool of claim 1, comprising two collet plates, each disposed on opposite sides of the collet element assembly.

5. The valve seat engagement tool of claim 1, further comprising a coupling configured to engage the threaded end of the mandrel on one side, and a threaded portion of an extension rod.

6. The valve seat engagement tool of claim 1, further comprising a hydraulic piston assembly, engageable about the threaded end of the mandrel, or an extension engaged with the threaded end of the mandrel, configured to be located external to a valve body in which the valve seat is disposed, and provide movement of the mandrel relative to the collet element assembly in the first direction.

7. The valve seat engagement tool of claim 1, wherein the tapered surface of the mandrel has a percent taper from about 0.5% to 7.5%.

8. The valve seat engagement tool of claim 1, wherein the outer curved faces have a thickness disposed parallel to an axis of the mandrel, which is dimensioned and arranged to releasably engage at least about 50% of a length of the inner diameter of the valve seat.

9. A method of using the valve seat engagement tool of claim 1, comprising
disposing the collet assembly into the inner diameter of the valve seat;
moving the mandrel relative to the collet element assembly in the first direction in an amount sufficient to engage the outer curved faces of the collet element assembly with the inner diameter of the valve seat to releasably engage the valve seat engagement tool with the valve seat.

10. The method of claim 9, wherein the valve seat is disposed within a valve body, and further comprising movement of the mandrel relative to the valve body to compress a seal located between the valve body and the valve seat.

11. The method of claim 10, wherein the moving of the mandrel comprises the use of a hydraulic cylinder located external to the valve body and directly or indirectly engaged with the threaded end of the mandrel.

12. The method of claim 10, further comprising moving the mandrel relative to the collet element assembly in the second direction in an amount sufficient to disengage the valve seat engagement tool from the valve seat.

13. The method of claim 12, wherein the moving of the mandrel in the second direction comprises one or more hammer blows directly or indirectly to the threaded end of the mandrel.

14. A method of using the valve seat engagement tool of claim 2, comprising:
disposing the collet assembly into the inner diameter of the valve seat;
moving the mandrel relative to the collet element assembly in the first direction in an amount sufficient to engage the outer curved faces of the collet element assembly with the inner diameter of the valve seat to releasably engage the valve seat engagement tool with the valve seat.

15. The method of claim 14, wherein the valve seat is disposed within a valve seat mounting portion of a valve body, and further comprising movement of the mandrel relative to the valve body to remove the valve seat from the valve seat mounting portion of the valve body.

16. The method of claim 15, wherein the moving of the mandrel comprises the use of a hydraulic cylinder located external to the valve body and directly or indirectly engaged with the threaded end of the mandrel.

17. The method of claim 14, further comprising:
moving the outer end of the removal stud away from the upper face of the removal biscuit in an amount sufficient to disengage the valve seat engagement tool from the valve seat.

18. The method of claim 14, wherein the moving of the outer end of the removal stud away from the upper face of the removal biscuit comprises one or more hammer blows directly or indirectly to the threaded end of the mandrel.
